(19) United States
(12) Patent Application Publication
(10) Pub. No.: US 2004/0226203 A1
(43) Pub. Date: Nov. 18, 2004

(54) Lighted articulated display assembly

(76) Inventors: Daniel J. Yenglin, Charlevoix, MI (US); Andrew W. Allen, Charlevoix, MI (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 10/843,175

(22) Filed: May 11, 2004

Related U.S. Application Data
(60) Provisional application No. 60/470,804, filed on May 15, 2003.

(51) Int. Cl. G09F 13/18

(52) U.S. Cl. 40/546

(57) ABSTRACT

A display-panel for displaying point-of-purchase information includes an outer panel adapted to house at least one light source. The frame also constrains a sandwich of an inner panel and a transparent front panel, between which is received the graphic image to be displayed. The front panel and inner panel are configured in a manner such that light transmitted into the transparent front panel through its peripheral edge is refracted toward the adjacent inner panel. The refracted light impinging upon the inner panel and image mounted thereto is reflected at an angle so to as to impinge upon the front panel and pass entirely through the front panel to be seen by an observer. The placement of the light near the perimeter of the front panel, coupled with the optical characteristics of the front panel and inner panel can be altered to provide unique optical effects for enhancing recognition by observers.

### REFERENCE TO RELATED APPLICATION

This application claims priority from U.S. Provisional Patent Application Serial No. 60/470,804, filed May 15, 2003.

### BACKGROUND OF THE INVENTION

1. Field of the Invention

This invention relates generally to displays and particularly to display panels for advertising or notices. More specifically, the invention concerns a low profile lighted display panel which is hinged to close an opening.

2. Discussion of the Related Art

To the best of applicant's knowledge, previous lighted display panels contained only static lighted panels. That is to say, any lighted advertisement or message remained stationary. Furthermore, applicant is not aware of any situation where it is disclosed that shelving door panels serve as a lighted sign. The following is a discussion of the related art concerning those two topics.

U.S. Pat. No. 4,903,423 in the name of Hinca discloses a sign holder comprising a housing including a back wall, opposed and spaced side walls extending from the back wall, and opposed and spaced top and bottom walls extending from the back wall and from the opposed side walls. A first panel of light transmitting plastic is removably supported by the housing. A second panel of clear plastic is supported by the housing in close position, yet behind the first panel, and in front of the rear wall to provide an illumination space. An image or indicia is fixed on the second panel preventing light transmission through the panel. A light source or bulb is in the housing behind the second panel for illuminating the space between the second panel and the rear wall, thereby lighting the indicia on the second panel from behind.

The U.S. Pat. No. 5,546,687 in the name of Iorfida discloses a transparent sheet of acrylic having a mirrored coating on its back surface. The front surface of the acrylic sheet has been abraded or ground and includes a layer of fluorescent paint. The fluorescent paint layer carries a cibachrome image transparency. Light passes through an edge of the sheet to the ground surface where it is diffused and amplified by the excitation of the fluorescent particles in the paint. The amplified light illuminates a back surface of the transparency, thereby providing a display of an illuminated image to an observer who views the image from a front surface of the transparency. The light in this case is powered by an AC source through a plug. The disclosure of the '687 patent lacks any mention or reference of mounting such a structure on a hinged door for concealing a storage space on a shelf or similar structure.

U.S. Pat. No. 5,457,905 issued to Kaplan in 1995 discloses a menu board or displaying artwork. The board includes a frame formed from a series of frame elements to form a box. The frame is superimposed on a light box having a transparent face plate forming the rear wall of a cavity and a transparent window plate is positioned to cover the recess. A flexible tape connects the window plate with the face plate for pivotal movement and defines a bight at the hinge. The window plate may be pivoted from a bight0opening position to a bight-closing position to accommodate the insertion of artwork. In this case the window plate is hinged and does not itself contain any light source.

U.S. Pat. No. 5,678,334 to Schoeniger concerns a display board such as used in advertising, information displays, road signs, and the like. The display includes a panel of transparent material which has at least one lighting element for illuminating the panel from at least one lateral edge. At least one of the two flat sides of the panel is at least partially covered with an opacifier film. The panel provided with the opacifier film is provided to backlight display symbols to be mounted onto the front flat side seen by an observer. The light reaching the contact face between the panel and opacifier film, from the panel into the opacifier film, is scattered by the opacification of the film, so that the entire opacifier film lights up and provides an evenly bright face for backlighting a panel provided with display symbols.

U.S. Pat. No. 5,915,855 to Murase et al. discloses a bar light source for an edge light panel and an illumination sign board using the same structure. The bar light source includes a rod of resin having a light source at one end. The rod is fixed periodically with spots where light escapes the rod to impinge upon a reflector which assists in directing light into the edge of a panel. The panel serves as a back light for highlighting indicia placed on the front surface of the panel. The patent focuses on the different methods of creating a light-guiding pattern on the resin rod.

U.S. Pat. No. 6,234,329 B1 to Loew discloses a storage and sales unit having a storage space and a display space. The storage space is covered by a hinged panel such that the panel can be raised and lowered to open and close the storage space respectively. The panel includes a frame adapted to receive graphics or other display elements. The display panel is designed to cover the storage area in the storage unit when the frame is in a closed position.

The patents and publications mentioned above fail to disclose or suggest a lighted display space on a hinged panel for concealing a storage space on a shelving or storage unit. Moreover, to the extent the publications disclose perimeter lighting; they all suffer from the disadvantage of loosing brightness due to signal loss from the light remaining within the transparent panel. The instant invention provides a unique and novel method and apparatus for providing a perimeter lighted panel resulting in the illumination of indicia located behind the light source, rather than one located in front of the light source.

### SUMMARY OF THE INVENTION

It is an object of this invention to provide a hinged display assembly for point-of-purchase shelving units having both a display shelf and a storage shelf.

It is another object of this invention to provide a lighted hinged display assembly that maximizes light transmission and image quality to attract the attention of consumers.

It is yet another object of this invention to provide a light display which is thin in profile yet provides significant improvement over prior edge-lit devices for displaying indicia or graphics contained within the display.

In accordance with those objectives and principals, one embodiment of the invention comprises a bracket assembly adapted to be attached to the shelving unit; and a lighted door assembly pivotally coupled to said bracket assembly. The lighted door assembly may include a first panel member; a second panel member adjacent the first panel member and adapted to retain an image in cooperation with the first panel member. A third panel member may be adapted to receive the first and second panel members in substantially parallel alignment; as well as at least one light source mounted adjacent an edge of the first panel member. The light source directs an amount of light into the first panel member and onto said second panel member to illuminate the indicia or graphics contained in the display.

In one embodiment, the bracket assembly may include at least one shelf arm for attachment to a standard or upright of the shelving unit. Attached to the edge of the shelf furthest from the standard may be an edge member. The edge member may be attached directly to the ends of the shelf arms or to the end of the shelf pan. A hinge member is provided to attach to the edge member and provide a pivotal coupling for the third panel. An umbilical in the form of an electrical cord is provided to supply electrical power to the lighted door assembly.

In another form of the invention, it is contemplated the first panel member includes an optically transparent panel such as acrylic, polycarbonate, or other transparent resin. It is further contemplated that the second panel member or intermediate panel is also formed from a resinous material, and more preferably has a predetermined curvature or form to maximize the redirection of incident light out through the transparent panel. This embodiment also contemplates a third panel is designed to house both the intermediate and clear panels as well as the light fixture located at the edges of the clear panel.

Regardless of the embodiment of the invention, the inventors foresee that the optically transparent panel may have predetermined optical characteristics such as a specific refractive index sequence or layers so as to direct a predetermined amount of light propagating through the optically transparent panel toward the intermediate panel. It is also contemplated that the back surface of the clear panel may be treated in one of a number of ways to create a controlled array of light ports that act in a manner to create an intentional angle of incidence so that a predetermined portion of the light is refracted toward the intermediate panel.

Another form of the invention concerns an articulated display panel assembly, comprising an optically transparent panel having a front surface and an opposing back surface having a common peripheral edge. The optically transparent panel is preferred to have a predetermined index of refraction for directing light propagating the generally parallel to the front and back surfaces out the back surface. Proximate the back surface of the transparent panel is an inner or intermediate panel. The inner panel provides a mounting surface for indicia or graphics, and is formed to provide maximum reflection of the light exiting the back surface of the transparent panel in a direction substantially normal thereto so as to pass through the transparent panel and be observed on the opposite side. The transparent panel and inner panel are held in close relationship by an outer member. The outer member also serves to retain at least one light source proximate the peripheral edge of the transparent panel for transmitting light into the transparent panel. The entire assembly including the outer member, the inner panel, transparent panel and light source may be mounted by at least one bracket to an edge of a shelf such that the assembly can pivot and serve as a door to a storage space.

The advantages provided by the invention include flexible display features adaptable for either fixed or hinged applications. In addition, the configuration of the transparent and intermediate panel substantially improves the visual prominence of the image or indicia mounted between the intermediate and front panels. In addition, by replacing an unlighted image with a lighted display converts an otherwise inconspicuous panel into a conspicuous and eye catching display. The dimensions of the lighted display can be adapted to fit substantially any application and accommodate a wide range of graphic or indicia. These and other objects and advantages of the invention will be better understood when taken in combination with the following description of the drawing figures and description of the different embodiments.

### BRIEF DESCRIPTION OF THE DRAWING FIGURES

FIG. 1 is an illustration of one application of the invention; and

FIG. 2 is an exploded view of the invention shown in FIG. 1.

### DESCRIPTION OF THE EMBODIMENT

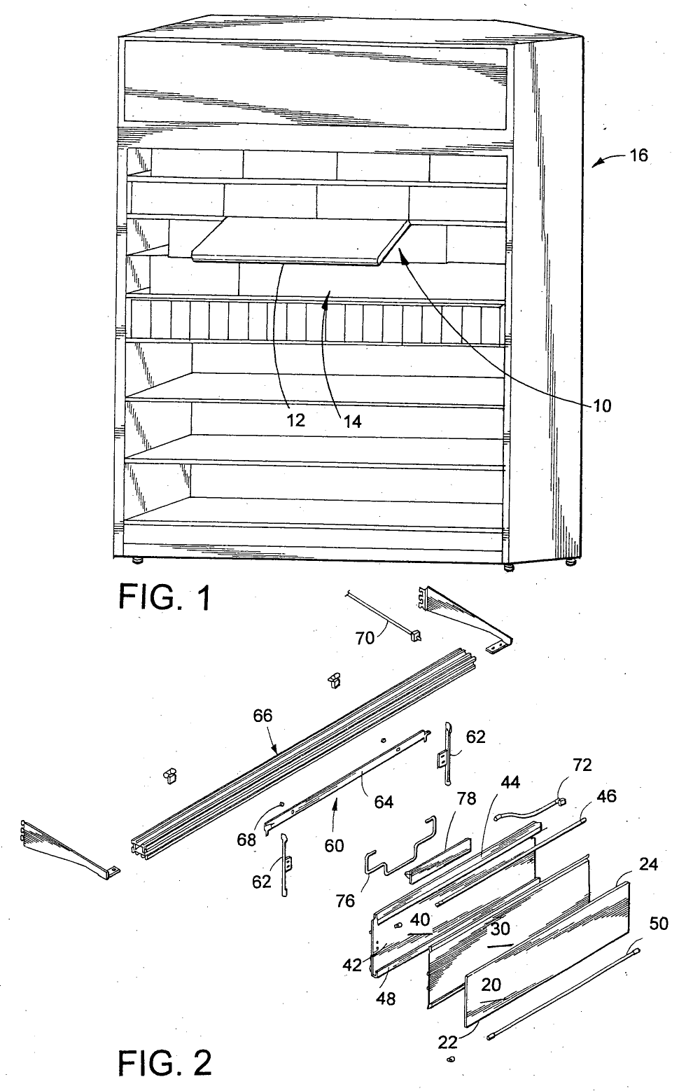

For purposes of the following description, the terms “upper,” “lower,” “left,’” “rear,” “front,” “vertical,” “horizontal’ and derivatives of such terms shall relate to the invention as oriented in FIG. 1. However, it is to be understood that the invention may assume various alternative orientations and configuration, except where expressly specified to the contrary. It is also to be understood that the specific devices and processes illustrated in the attached drawings, and described in the following specification are simply exemplary embodiments of the inventive concepts defined in the inventive concepts of this invention. Specific dimensions and other physical characteristics relating to the embodiments disclosed herein are not to be considered as limiting unless expressly stated otherwise.

The invention concerns a display or panel assembly such as identified by reference numeral 10 shown in FIGS. 1 and 2. In particular the articulated display panel assembly 10 is intended to receive interchangeable graphics and/or indicia (not shown) containing advertising or notices. In one embodiment, the assembly 10 may serve as a static display held in substantially a fixed orientation. Yet in another embodiment, the assembly 10 may be fixed to, or act as, a door 12 covering a storage area 14 in a storage cabinet or shelving unit 16. In addition to acting as a door 12, the assembly 10 provides a display surface which is highly visible. Details of the assembly are described below. For purposes of clarity, the invention will be described as a display or assembly, although other terms may also be suitable such as panel, panel assembly, lighted-display, lighted-panel, display assembly, and the like. Such terms are to be interpreted in a manner consistent with the structure shown and described herein.

Referring more specifically to FIG. 2, the display or panel assembly 10 is shown in an exploded view. The panel assembly 10 includes a transparent front panel or sheet 20 of predetermined dimensions. In the embodiment shown in FIGS. 1 and 2, it is contemplated that the display has a width greater than its height, although other configurations are certainly possible. The reasons for this particular profile will become readily apparent below. Because of the position of the panel, it is preferred that it be transparent although there is no requirement that it be optically clear. However, in the preferred embodiment it is desired the front panel 20 be optically clear so an observer -may see a display positioned on the opposite side of the panel 20. Suitable materials for panel 20 may include silica or resin-based products such as glass, acrylic, polycarbonate, and the like. The panels my have homogeneous or heterogeneous optical properties depending upon the desired applications. However, in the instant invention it is anticipated and preferred the panel be formed in a manner to maximize illumination of the material to be displayed to be viewed by an observer. For example, it is preferred the optical properties of panel 20 be designed such that light propagating therein generally parallel to the front and back surfaces (i.e. entering from edge 22 and generally perpendicular to the narrowest dimension) be refracted in a preferred pattern out the back surface 24. Conversely, it is preferred that light propagating within a preferred angle generally parallel to the narrowest dimension pass through the panel 20 without retardation so as to be seen by the observer. In order to achieve this optical characteristic, the optical properties of the panel require special manipulation in order to achieve the desired indices of refraction for the visible wavelengths of light.

It is contemplated one method for forming the panel 20 may be by formulating a panel of homogeneous material where the index of refraction is fixed such that light impinging upon the back surface of the panel 20 within a specified angle of incidence is refracted such that it exits back of the panel 20 and is reflected by the display. It is known that such may be controlled in the formulation of glass and similar materials. In the case of resinous materials, it is envisioned similar techniques may also be used in the making of such panels by altering the composition to some degree. It is also envisioned the optical properties may also be altered by laminating layers of resin of different properties to create light paths that provide unique optical affects. Alternatively and perhaps the most economic technique to change the optical character of such panels is to treat one surface of the panel so as to manually create spots where light my “leak” in a controlled fashion from the panel. Such treatment may include abrading one or both surfaces of the panel, providing grooves, indentations, domes, pyramids or other trapezoidal form or alterations to one surface such as 24. These physical structures provide surfaces on back surface 24 where the light in panel 20 impinges at an angle of incidence that enhances the refraction of light waves out surface 24. Regardless of the technique adopted, it is certainly an object of this invention to refract a substantial portion of the light propagating within (in contrast to through) panel 20 out surface 24 in a manner to illuminate or light-up the image positioned adjacent or proximate surface 24.

Next to panel 20 is an inner or intermediate panel 30 intended to cooperate with panel 20 to form a space for graphics or other displays. In addition, panel 30 is also intended to provide a substrate for enhancing the reflection of light impinging upon the display so it can be viewed by the observer. In one embodiment, it is envisioned that panel 30 may be formed from a polymeric material. Depending upon the desired optical characteristics, panel 30 may be made from either a light-reflecting material or a light-absorbing material. However, in the preferred embodiment, panel 20 is preferably formed from a polymeric material using an extrusion method. Using the extrusion method, the profile of the panel 30 can be controlled and more consistent in terms of thickness and surface luster and texture. In the role of reflector, the radius of curvature of member 30 will have an impact on the brilliance of the image. As seen in the drawing figure, it is preferred the radius be convex toward front panel 20 for reasons that will become more apparent below. In addition, the profile of the intermediate panel may be varied to provide special optical effects. For example, it is contemplated that certain areas of panel 30 may have a concave or trough profile while other areas may be convex or wave form to focus or diffuse the light reflected from the display. Although panel 30 is described as extruded, other methods and materials may also be used to provide a backdrop or substrate for the graphic image to be displayed. Such could include glass-type materials with or without mirrored characteristics and truly dependent upon the desired optical goal.

Front panel 20, the intermediate panel 30, and any graphical display sandwiched between the two (not shown) are retained by a third panel 40. The third panel 40 preferably has a substantially C-shaped vertical profile having a generally planar intermediate web or mid-section 42 terminating in specially formed channels 44 and 48 at the upper and lower ends of web 42, respectively. The upper and lower channels 44 and 48 are configured to retain lamps designated by numerals 46 and 50 outboard of the perimeter or peripheral edges of panels 20 and 30. Both lamps 46 and 50 are preferably low-voltage and/or low-profile light sources to reduce the chance of electrical shock. Such light sources could include tubular waveguides such as acrylic or polycarbonate rods ground at predetermined spots along one edge to provide exit points for light propagating therein. Alternatively, fluorescent or neon tubes may be used. The type of light source is not as critical as is the position of the source adjacent or otherwise proximate the peripheral edges of the first and second panels constrained within the third panel 40. For it is an object of this invention to provide a low-profile display as well so the position of the light sources are an important aspect of the assembly.

In a preferred embodiment, the third panel 40 may also be formed from a polymeric material using the same technique used to manufacture the second or inner panel 30. The outer panel 40 not only forms the housing for inner panel 30 and front panel 20, but also provides the principal framework for the assembly 10. Additional structure may also be provided in the upper and lower channels 44 and 48 to accommodate the light sources 46 and 50. These could include mounting hardware and/or light terminals for the lamps as well as reflectors positioned on the side of the lamps opposite that proximate the edges of the front panel 20.

Additionally, an alternate embodiment of the invention contemplates that upper and lower channels 44 and 48 may be adapted to receive ends 62 of a bracket 60. The ends 62 of the bracket 60 serve as pivot points about which panel 40 may swing if intended to act as a door. Should it be desired to hinge the panel 40 from the top edge, the pins 62 may be received within the upper channel 44. Conversely, should it be desired to hinge the panel 40 at the lower edge, pins 62 may be received within the lower channel 48. In either event, end caps such as 64 may be used to provide a finished appearance to panel 40 as well as retain the ends 62 of the bracket within the respective channel. In the hinged form of the display panel, it is contemplated that the blade-like intermediate section or web 66 of the bracket 60 may be mounted directly in its simplest form to the edge of the shelf. Alternatively, and as shown in the drawing figures, the intermediate section 66 may also be received within a channel 67 and fixed in position by fasteners 68. In this embodiment, the channel 67 may be supported by arms 69 having fingers or other suitable structures for engaging the uprights of the shelving assembly. Using this design, a shelf may be formed by simply placing a panel on top of the arms and channel. Certainly the instant invention can be adapted to substantially any shelving environment. In the embodiment show, slotted brackets are one example.

Power is provided to the lamps 46 and 50 by any one of a number of methods. However, it is contemplated that in one embodiment using neon or fluorescent sources, an electrical cord 70 would have one end connected to a power source and the other end coupled to the lamps and concealed by the end caps 64. In the case of optical waveguides, the cable may connect to lamps positioned at the ends of the optical light tubes. In yet another embodiment, fiber optic cables my run from a remote light source outside of the display assembly 10 to the optical rods mentioned above. Depending upon the desired application, insulators, wire races and other accommodations should be considered for concealing the conductors and waveguides/rods.

If special point-of-sale displays are desired such as sale or price tags, a flip-down-flip-up bail 76 may be pivotally coupled to a lock plate 78 attached to the rear surface of the outer member 40. The longitudinal position of lock plate 78 may be changed provided the lock plate 78 is fixed to the back of member 40 by way of a channel similar to that of bracket 60 and channel 67. Accommodations may also be used to secure the outer member 40 over any storage space it's covered. For example, the lock plate 78 may be fixed with a locking mechanism adapted to interact or mate with a complimentary structure fixed to the shelf of the storage space. Moreover, latching mechanisms may be provided along the upper edge of the panel 40 in those instances where it was desired to provide hinging along the bottom channel 48. Such could include magnetic latches as well as more mechanical forms requiring the depression of a lever or button.

In operation, the particular message to be conveyed in the form of text, artwork or a combination is printed on a flexible medium sized to fit between inner panel 30 and transparent panel 20. The activation of lamps 46 and 50 introduces light into panel 20 which is refracted and reflected to illuminate the image. A substantial portion of that light energy is reflected from the image in substantial part by the convex profile of the image mounted to reflector/inner panel 30, and completely through panel 20 to be seen by the observer. Moreover, the user may conceal/store product or materials out of view behind the suspended display assembly.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention.

We claim as our invention:

1. An articulated display panel assembly, comprising in combination:
an optically transparent panel having a front surface and an opposing back surface and a common peripheral edge, said optically transparent panel having a predetermined refractive index for refracting a percentage of light propagating within said optically transparent panel out from said back surface;
an intermediate panel adjacent said back surface of said optically transparent panel for directing a percentage of the-light refracted from said back surface of said optically transparent panel back into said optically transparent panel at an angle outside a critical angle of incidence for said optically transparent panel;
an outer member for receiving said optically transparent panel and said intermediate panel;
at least one light source mounted within said outer member and adjacent said optically transparent panel for transmitting an amount of light into said optically transparent panel; and
at least one bracket attached to a predetermined portion of said outer member for coupling said outer member to an edge of a shelf.

2. The articulated display panel assembly as defined in claim 1, wherein said back surface of said optically transparent panel further includes a surface for directing a percentage of said light propagating within said optically transparent panel toward said intermediate panel.

3. The articulated display panel assembly as defined in claim 1, wherein said intermediate panel has a predetermined profile to enhance the reflection of light impinging thereon.

4. The articulated display panel assembly as defined in claim 1, wherein said outer member includes at least one channel for retaining said optically transparent panel and said intermediate panel.

5. The articulated display panel assembly as defined in claim 1, wherein said at least one light source is disposed adjacent at least one peripheral edge of said optically transparent panel.

6. The articulated display panel assembly as defined in claim 1, further comprising a wiring harness for connecting said at least one light source to a source of electricity.

7. The articulated display panel assembly as defined in claim 1, wherein said at least one bracket includes a hinge for pivotally coupling said outer member to said edge of said shelf.

8. The articulated display panel assembly as defined in claim 1, further including a handle assembly coupled to a predetermined portion of said outer member.

9. The articulated display panel assembly as defined in claim 1, further comprising a lock plate coupled to a predetermined portion of said outer member.

10. The articulated display panel assembly as defined in claim 1, further comprising end members attached to said outer member for concealing at least a portion of said peripheral edge of said optically transparent panel.

11. The articulated display panel assembly as defined in claim 1, wherein said back surface of said optically transparent includes one of dimples, domes, ridges, grooves, pyramids, trapezoids, and coatings to transmit light propagating within said optically transparent panel out said back surface.

12. An edge-lit display panel assembly for use on shelving, comprising in combination:
a bracket assembly for coupling the panel assembly to the shelving;
an outer member coupled to said bracket assembly and suspended from said bracket assembly;
an inner panel adapted to be disposed within said outer member;
an optically transparent panel adapted to be disposed adjacent said inner panel and retained by said outer member; and
at least one light source disposed along an edge of said optically transparent panel for transmitting light into said optically transparent panel and at least a portion directed toward said inner panel.

13. The edge-lit display panel assembly as defined in claim 12, further comprising a hinge bracket defined in said bracket assembly for pivotally coupling said outer member to said bracket assembly.

14. The edge-lit display panel assembly as defined in claim 12, further comprising a handle assembly attached to said outer member.

15. The edge-lit display panel assembly as defined in claim 12, wherein said optically transparent panel and said inner panel are shaped to best illuminate an image sandwiched between said optically transparent panel and said inner panel.

16. The edge-lit display panel assembly as defined in claim 12, further comprising an umbilicus for coupling said at least one light source to a source of electricity.

17. The edge-lit panel display assembly as defined in claim 12, further comprising a handle pivotally coupled to said outer member.

18. The edge-lit panel display assembly as defined in claim 12, wherein said optically transparent panel comprises one of an optically flat panel, and an optically curved panel.

19. The edge-lit panel display assembly as defined in claim 12, wherein a surface of said optically transparent panel includes a predetermined texture for directing a portion of the light transmitted into said panel towards said inner panel.

20. The edge-lit panel display assembly as defined in claim 12, wherein said outer member includes end caps for enclosing said inner panel and said optically transparent panel within said outer member.

21. A hinged display panel assembly for point-of-purchase shelving units, comprising:
a bracket assembly adapted to be attached to the shelving unit; and
a lighted door assembly pivotally coupled to said bracket assembly.

22. The hinged display panel assembly as defined in claim 21, wherein said lighted door assembly includes:
a first panel member;
a second panel member adjacent said first panel member and adapted to retain an image in cooperation with said first panel member;
a third panel member adapted to receive said first and second panel members in substantially parallel alignment; and
at least one light source mounted within said third panel member and adjacent an edge of said first panel member for directing an amount of light into said first panel member and onto said second panel member.

23. The hinged display panel assembly as defined in claim 21, wherein said bracket assembly includes:
at least one shelf arm for attachment to a shelf standard;
at least one shelf edge member attached to a terminal end of said at least one shelf arm; and
a hinge member attached to said shelf edge member and adapted to be pivotally coupled to said third panel.

24. The hinged display panel assembly as defined in claim 21, further including an umbilicus for providing electrical power to said lighted door assembly.

25. The hinged display panel assembly as defined in claim 22, wherein said first panel member includes an optically transparent panel.

26. The hinged display panel assembly as defined in claim 22, wherein said second panel member includes an inner panel.

27. The hinged display panel assembly as defined in claim 22, wherein said third panel member includes an outer member.

28. The hinged display panel assembly as defined in claim 23, wherein said at least one shelf edge member includes at least one channel for receiving said hinge member.

29. The hinged display panel assembly as defined in claim 25, wherein said optically transparent panel includes one of predetermined refractive index so as to direct a portion of light propagating through said optically transparent panel is refracted toward said second panel.

30. The hinged display panel assembly as defined in claim 26, wherein said inner panel includes a predetermined profile for directing light impinging thereon back through said first panel.

31. The hinged display panel assembly as defined in claim 27, wherein said outer member supports said first and second panel members in substantially parallel relationship.

32. A method for displaying an illuminated image on a hinged panel, comprising the steps of:
mounting the image to be illuminated to a surface of the hinged panel;
covering the image with a transparent panel of predetermined refractive index;
transmitting light into said transparent panel along a perimeter edge of said transparent panel such that the refractive index of said transparent panel directs a portion of the light propagating therein toward said image; and
reflecting said light directed toward said image back through said transparent panel to be viewed by an observer.

33. The method as defined in claim 32, further comprising the step of mounting the image to be illuminated on a panel of predetermined profile for reflecting the maximum amount of light back through said transparent panel.
